(19) United States
(12) Patent Application Publication
(10) Pub. No.: US 2005/0162536 A1
(43) Pub. Date: Jul. 28, 2005

(54) Imaging device

(75) Inventors: Masahiro Oda, Itami-shi (JP); Makoto Izumi, Mizuho-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/033,303

(22) Filed: Jan. 12, 2005

(30) Foreign Application Priority Data
Jan. 28, 2004 (JP) JP2004-019233

(51) Int. Cl. H04N 3/14

(52) U.S. Cl. 348/302; 348/308

(57) ABSTRACT

The present invention provides an imaging device capable of suppressing deterioration of image quality due to shortage of the amount of light. The imaging device comprises an imaging part which performs photoelectric conversion; a mixing part which mixes electrons corresponding to at least two of pixels transferred from the imaging part; and an electron-ejection gate electrode which has a length in the transfer direction smaller than the length in the transfer direction of a gate electrode of later stage and ejects the electrons mixed by the mixing part.

### BACKGROUND OF THE INVENTION

1. Field of the Invention

The present invention relates to an imaging device, and more particularly to an imaging device having an imaging part.

2. Description of the Background Art

An imaging device such as a digital camera having an imaging part which performs photoelectric conversion is known, in general. This type of imaging device is disclosed in “KOTAISATSUZOSOSHI NO KISO” (ANDO, Takao and KOMOBUCHI, Hiroyoshi, NIHON RIKO SHUPPANKAI, 5 Dec. 1999, pp 3-7), for example. In the aforementioned conventional imaging device is provided with a plurality of pixels arranged in a matrix shape in the imaging part, and performs photoelectric conversion from light incident on the pixels. An imaging device which provides preview mode that quickly captures an image to display the subject by quickly outputting photoelectrically converted electrons separately from taking of photographs is also known, in general.

In the aforementioned preview mode, since it is necessary to set time of photoelectric conversion for one frame into 1/30 second or less in the case where electrons corresponding to 30 frames are provided in one second, there is a disadvantage that electrons produced in the imaging part decrease. Recently, an imaging device provided with over one million pixels in the imaging part has been developed by making pixel size finer. In the case where pixel size becomes finer as mentioned above, light incident on one pixel decreases. In this case, there is also a disadvantage that electrons produced in the imaging part decrease. In addition, in the case where photographs are taken in the dark, since light incident on pixels decreases, there is a disadvantage that electrons produced in the imaging part further decrease. As a result, there is a problem that it is difficult to suppress deterioration of image quality due to shortage of the amount of light.

### SUMMARY OF THE INVENTION

The present invention is aimed at solving the above problems, and it is one object of the present invention to provide an imaging device capable of suppressing deterioration of image quality due to shortage of the amount of light.

To achieve the above object, an imaging device according to one aspect of the present invention comprises an imaging part which performs photoelectric conversion; a mixing part which mixes electrons corresponding to at least two of pixels transferred from the imaging part; and an electron-ejection gate electrode which has a length in the transfer direction smaller than the length in the transfer direction of a gate electrode of later stage and ejects the electrons mixed by the mixing part.

In the imaging device according to the one aspect, the mixing part which mixes the electrons corresponding to at least two of pixels transferred from the imaging part is provided, and thus can output the mixed electrons after mixing the electrons corresponding to at least two of pixels transferred from the imaging part. As a result, it is possible to suppress deterioration of image quality due to shortage of the amount of light, even if the electrons produced in the imaging part decrease and the electrons transferred from the imaging part decrease. Furthermore, the electron-ejection gate electrode which ejects the electrons mixed by the mixing part is provided, and thus can easily eject excess electrons that do not affect image quality when electrons more than necessary are mixed in the mixing part. In this case, the length of the electron-ejection gate electrode in the transfer direction is smaller than the length in the transfer direction of the gate electrode of later stage, thus, the potential well formed by the electron-ejection gate electrode can be smaller than the potential well formed by a gate electrode of later stage. Accordingly, the electrons that can be stored in the potential well formed by the electron-ejection gate electrode are fewer than those in the potential well formed by a gate electrode of later stage. This allows quick ejection of the excess electrons. For this reason, since the excess electrons can be quickly ejected even if electrons more than necessary are mixed in the mixing part, long time is not required for ejection of the excess electrons. As a result, in the case where the electrons corresponding to at least two pixels are mixed to suppress deterioration of image quality due to shortage of the amount of light, it is possible to suppress reduction of transfer rate. Therefore, it is possible to suppress occurrence of light noise (smear) due to incident of light in transfer.

In the aforementioned imaging device according to the one aspect, preferably, the electron-ejection gate electrode is provided in the mixing part, and forms an potential well which serves to mix the electrons corresponding to the at least two of the pixels transferred from the imaging part and to eject the mixed electrons. With this constitution, electrons corresponding to at least two of pixels are mixed by one electron-ejection gate electrode in the mixing part, and it is possible to quickly eject excess electrons that do not affect image quality.

In the aforementioned constitution where the electron-ejection gate electrode forms the potential well which serves to mix the electrons corresponding to the at least two of the pixels transferred from the imaging part and to eject the mixed electrons, preferably, a potential well for mixing the electrons corresponding to the at least two of the pixels is formed by setting a signal provided to the electron-ejection gate electrode to a prescribed potential level, and the prescribed potential level of the signal provided to the electron-ejection gate electrode is held during a period where the electrons corresponding to the at least two of the pixels are transferred to the potential well. With this constitution, in the potential well formed by the electron-ejection gate electrode, electrons corresponding to at least two of the pixels can be easily mixed.

In the aforementioned constitution where the prescribed potential level of the signal provided to the electron-ejection gate electrode is held during the period where the electrons corresponding to the at least two of the pixels are transferred to the potential well, preferably, the electron-ejection gate electrode ejects the electrons the number of which is beyond the number of the electrons that can be stored in the potential well formed by the electron-ejection gate electrode. With this constitution, in the potential well formed by the electron-ejection gate electrode, it is possible to easily provide both mixing of electrons corresponding to at least two of pixels and quick ejection of excess electrons that do not affect image quality.

In the aforementioned imaging device according to the one aspect, preferably, the mixing part mixes the electrons corresponding to adjacent three of the pixels in the transfer direction transferred from the imaging part. With this constitution, after electrons corresponding to adjacent three of pixels in the transfer direction are mixed, the mixed electrons can be output.

In the aforementioned imaging device according to the one aspect, preferably, the mixing part includes an electron-mixing gate electrode which mixes the electrons corresponding to the at least two of the pixels transferred from the imaging part, and the electron-ejection gate electrode is arranged in a later stage relative to the electron-mixing gate electrode of the mixing part. With this constitution, in the mixing part, even in the case where the amount of excess electrons ejected by the electron-mixing gate electrode is small, in a later stage relative to the mixing part, the excess electrons can be quickly ejected. In addition, since excess electrons are ejected in two parts of the mixing part provided with the electron-mixing gate electrode and a later stage relative to the mixing part provided with the electron-mixing gate electrode in a distributed manner, it is possible to reduce both the numbers of excess electrons that are ejected in the mixing part and in the later stage relative to the mixing part. Accordingly, it is possible to suppress that excess electrons ejected from the potential wells formed by the electron-mixing gate electrode and the electron-ejection gate electrode are mixed into each of the potential wells formed at the outsides of the gate electrodes located at the both sides in the transfer direction of the electron-mixing gate electrode and the electron-ejection gate electrode, respectively. Therefore, it is possible to further suppress deterioration of image quality.

In the aforementioned constitution where the electron-mixing gate electrode is included and the electron-ejection gate electrode is arranged in the later stage relative to the electron-mixing gate electrode, preferably, the electron-mixing gate electrode of the mixing part has a length in the transfer direction longer than the length in the transfer direction of the electron-ejection gate electrode. With this constitution, it is possible to further reduce the amount of ejection of excess electrons in the mixing part easily. Accordingly, it is possible to suppress that excess electrons ejected from the potential well formed by the electron-mixing gate electrode are mixed into each of the potential wells formed at the outsides of the gate electrodes located at the both sides in the transfer direction of the electron-ejection gate electrode.

In the aforementioned imaging device according to the one aspect, preferably, the apparatus includes at least two the electron-ejection gate electrodes, and the respective lengths in the transfer direction of the at least two electron-ejection gate electrodes decrease as they are positioned later in stages. With this constitution, excess electrons are ejected in three parts or more of the mixing part provided with the electron-mixing gate electrode and later stages relative to the mixing part provided with the at least two electron-ejection gate electrodes in a distributed manner. Accordingly, it is possible to further reduce the number of excess electrons ejected in the potential wells formed by the mixing part and each number of excess electrons ejected in each of the at least two electron-ejection gate electrodes. As a result, it is possible to further suppress that excess electrons ejected from the potential wells formed by the electron-mixing gate electrode and the electron-ejection gate electrode are mixed into each of the potential wells formed at the outsides of the gate electrodes located at the both sides in the transfer direction of the electron-mixing gate electrode and the electron-ejection gate electrode, respectively. Therefore, it is possible to further suppress deterioration of image quality.

In the aforementioned constitution where the at least two electron-ejection gate electrodes are provided, preferably, one of the at least two electron-ejection gate electrodes is provided in the mixing part, an potential well formed by the electron-ejection gate electrode of the mixing part serves to mix said electrons corresponding to the at least two of the pixels transferred from the imaging part and to eject the mixed electrons. With this constitution, electrons corresponding to at least two of pixels are mixed by one of the at least two electron-ejection gate electrodes in the mixing part, and it is possible to quickly eject excess electrons that do not affect image quality.

In the aforementioned constitution where the one of the at least two electron-ejection gate electrodes is provided in the mixing part, preferably, the number of the electrons ejected by the electron-ejection gate electrode of the mixing part is smaller than the number of the electrons ejected by the electron-ejection gate electrode positioned in a later stage relative to the mixing part. With this constitution, since the number of excess electrons ejected in the mixing part can be decreased, it is possible to suppress that excess electrons ejected from the mixing part are mixed into each of the potential wells formed at the outsides of the gate electrodes located at the both sides in the transfer direction of the mixing part.

In the aforementioned imaging device according to the one aspect, preferably, gate electrodes positioned at the both sides in the transfer direction of the electron-ejection gate electrode have lengths in the transfer direction longer than the length of the electron-ejection gate electrode in the transfer direction. With this constitution, it is possible to elongate the interval in the transfer direction between the potential well formed by the electron-ejection gate electrode and each of the potential wells formed at the outsides of gate electrodes located at both sides in the transfer direction of the electron-ejection gate electrode. Accordingly, it is possible to suppress that electrons ejected from the potential well formed by the electron-ejection gate electrode pass over the potential barriers formed under the gate electrodes located at both sides in the transfer direction of the electron-ejection gate electrode, and are mixed into the adjacent potential wells. Therefore, it is possible to further suppress deterioration of image quality.

In the aforementioned imaging device according to the one aspect, the device further comprises a storage part which stores the electrons, which are produced due to the photoelectric conversion and transferred from the imaging part, and the electrons mixed by the mixing part are transferred to the storage part. With this constitution, it is only required to store mixed electrons corresponding to at least two of the pixels as electrons corresponding to one pixel in the storage part. This can provide the formation area of the storage part that is smaller than the formation area of the imaging part. Therefore, it is possible to achieve size reduction of imaging device, such as a frame transfer type imaging device having a storage part.

In the aforementioned constitution where the storage part is further provided, preferably, the storage part serves to store the electrons corresponding to the at least two of the pixels as electrons corresponding to one pixel. With this constitution, electrons corresponding to at least two of the pixels mixed in the mixing part can be stored in the storage part.

In the aforementioned constitution where the storage part is further provided, preferably, the mixing part is provided in a part of the storage part proximity to a boundary between the imaging part and the storage part. With this constitution, after electrons corresponding to the at least two of the pixels transferred from the imaging part are mixed in the mixing part, it is possible to easily transfer the mixed electrons to the storage part.

In the aforementioned constitution where the mixing part is provided in the part of the storage part proximity to a boundary between the imaging part and the storage part, preferably, the electron-ejection gate electrode is provided in the mixing part located in the part of the storage part proximity to a boundary between the imaging part and the storage part. With this constitution, in the mixing part located in the part of the storage part proximity to a boundary between the imaging part and the storage part, the electron-ejection gate electrode can provide both mixing of electrons corresponding to at least two of pixels and quick ejection of excess electrons that do not affect image quality.

In the aforementioned constitution where the electron-ejection gate electrode is provided in the mixing part located in the part of the storage part proximity to a boundary between the imaging part and the storage part, preferably, the electron-ejection gate electrode has a length in the transfer direction smaller than the length of the gate electrode of the storage part in the transfer direction. With this constitution, it is possible to easily eject excess electrons that do not affect image quality when electrons more than necessary are mixed in the mixing part located in the part of the storage part proximity to a boundary between the imaging part and the storage part.

In the aforementioned constitution where the electron-ejection gate electrode is provided in the mixing part located in the part of the storage part proximity to a boundary between the imaging part and the storage part, preferably, the gate electrode of the imaging part adjacent to the electron-ejection gate electrode has a length in the transfer direction longer than the length of the electron-ejection gate electrode in the transfer direction, and the gate electrode of the storage part adjacent to the electron-ejection gate electrode has a length in the transfer direction longer than the length of the electron-ejection gate electrode in the transfer direction. With this constitution, it is possible to elongate the interval in the transfer direction between the potential well formed by the electron-ejection gate electrode and the potential well formed at the outside of the gate electrode of the imaging part adjacent to the electron-ejection gate electrode. In addition, it is also possible to elongate the interval between the potential well formed by the electron-ejection gate electrode and the potential well formed at the outside of the gate electrode of the storage part adjacent to the electron-ejection gate electrode in the transfer direction. Accordingly, it is possible to suppress that electrons ejected from the potential well formed by the electron-ejection gate electrode pass over the potential barriers formed under the respective gate electrodes of the imaging part and the storage part, which are adjacent of the electron-ejection gate electrode, and are mixed into the adjacent potential wells. As a result, in the imaging device where the electron-ejection gate electrode is provided in the mixing part located in the part of the storage part proximity to a boundary between the imaging part and the storage part, it is possible to suppress deterioration of image quality.

In the aforementioned constitution where the storage part is further provided, preferably, the imaging part, the mixing part, and the storage part are driven based on a plurality of phases of clock pulse signals, and in each of the imaging part and the storage part, the length in the transfer direction of at least one gate electrode in the imaging part, the mixing part, and the storage part is adjusted so that the load capacities of the respective gate electrodes of phases are substantially equal to each other. With this constitution, it is possible to suppress deviation of timing of turning to ON state or OFF state of the gate electrodes due to occurrence of difference among the load capacities of the respective gate electrodes of phases.

In this case, preferably, a plurality of gate electrodes which are adjusted so that their lengths in the transfer direction are longer than other gate electrodes are included as the gate electrodes with the adjusted length in the transfer direction, and the plurality of gate electrodes, which are adjusted so that their lengths in the transfer direction are larger, are arranged so that they are not adjacent to each other. With this constitution, it is possible suppress increase of area where an electric field is generated due to simultaneously turning to ON state of the gate electrodes adjacent to each other which are adjusted so that their lengths in the transfer direction are larger. Accordingly, it is possible to suppress recombination of electrons in the surface of substrate or inflow of electrons from the substrate.

### BRIEF DESCRIPTION OF THE DRAWINGS

FIG. 1 is a block diagram showing the whole constitution of an imaging device according to a first embodiment of the present invention;

FIG. 2 is a plan view showing an imaging part and a storage part of the imaging device shown in FIG. 1;

FIG. 3 is a cross-sectional view taken along the line 100-100 of FIG. 2;

FIG. 4 is a timing chart for illustrating the operation of the imaging device according to the first embodiment of the present invention;

FIG. 5 is a graph showing a simulation result of the state of about 18,000 electrons ejected from a potential well to which the electrons are transferred in the case where the lengths in the transfer direction of gate electrodes are varied;

FIG. 6 is a plan view showing an imaging part and a storage part of an imaging device according to a second embodiment of the present invention;

FIG. 7 is a plan view showing an imaging part and a storage part of an imaging device according to a third embodiment of the present invention;

FIG. 8 is a plan view showing an imaging part and a storage part of an imaging device according to a fourth embodiment of the present invention; and

FIG. 9 is a plan view showing an imaging part and a storage part of an imaging device according to a fifth embodiment of the present invention.

### DESCRIPTION OF THE PREFERRED EMBODIMENTS

Embodiments of the present invention are now described with reference to the drawings.

### First Embodiment

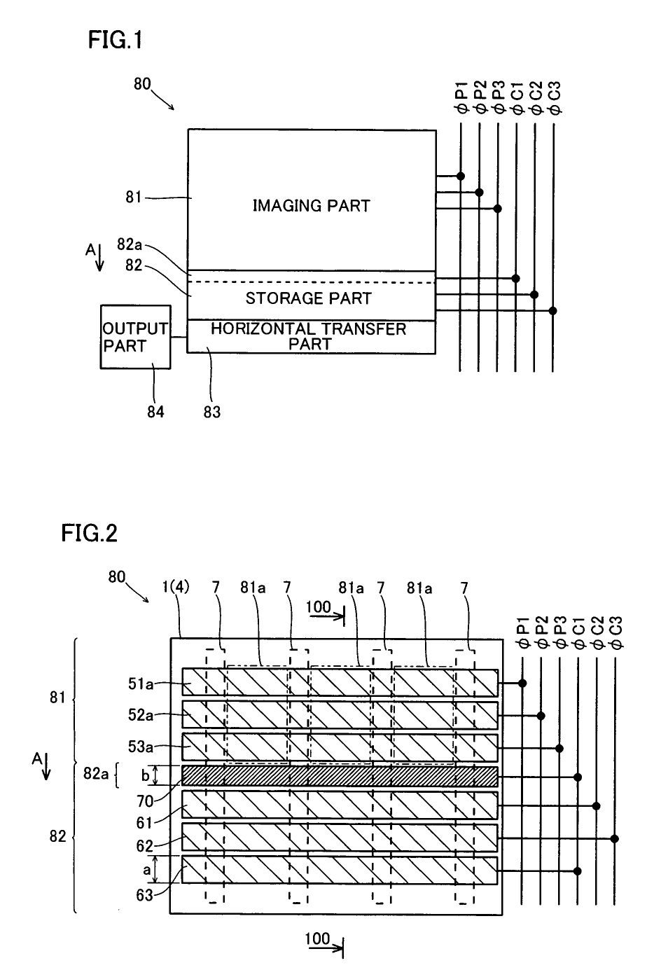

With reference to FIGS. 1 to 3, in a first embodiment, an exemplary frame transfer type imaging device to which the present invention is applied is described.

The frame transfer type imaging device 80 according to the first embodiment comprises an imaging part 81, a storage part 82, a horizontal transfer part 83, and an output part 84, as shown in FIG. 1. The imaging part 81 has a plurality of pixels 81a (see FIG. 2), which perform photoelectric conversion from light incident thereon and are arranged in a matrix shape. The imaging part 81 serves to store electrons produced due to photoelectric conversion and to transfer the electrons to the storage part 82 (direction A). The storage part 82 serves to store the electrons transferred from the imaging part 81 and to transfer the electrons to the horizontal transfer part 83 (direction A). The horizontal transfer part 83 serves to sequentially transfer the electrons transferred from the storage part 82 to the output part 84. The output part 84 serves to output the electrons transferred from the horizontal transfer part 83 as an electrical signal. Three phases of clock pulse signals FP1 to FP3 for transferring electrons are provided to the imaging part 81. Three phases of clock pulse signals FC1 to FC3 for transferring electrons are provided to the storage part 82.

In the first embodiment, a mixing part 82a for mixing electrons corresponding to three pixels 81a (only one pixel in the transfer direction is shown in FIG. 2) aligned in the transfer direction (direction A) is provided in a part of the storage part 82 proximity to a boundary between the imaging part 81 and the storage part 82. The clock pulse signal FC1 is provided to the mixing part 82a.

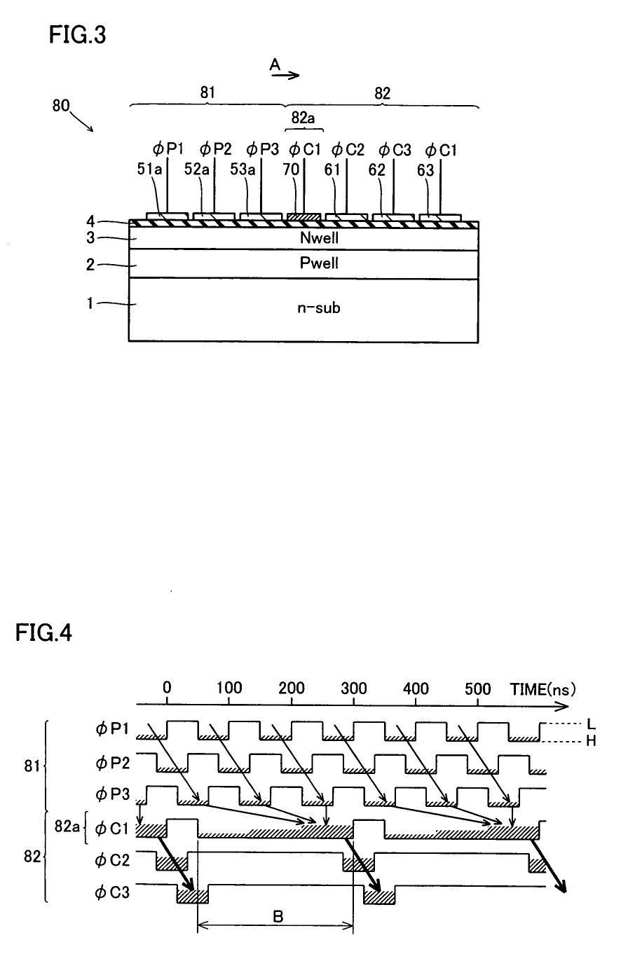

Referring to the cross-sectional structure of the imaging device 80, as shown in FIG. 3, a P-well 2 is formed on the surface of an n-type silicon substrate 1. An N-well 3 is formed on the surface of the P-well 2. As shown in FIGS. 2 and 3, gate electrodes 51a to 53a of polysilicon with thickness of about 70 nm are formed above the N-well 3 of the n-type silicon substrate 1 located in the imaging part 81 interposed a gate insulating film 4 of SiO₂ with thickness of about 70 nm therebetween. Gate electrodes 61 to 63 of polysilicon with thickness of about 70 nm are formed above the N-well 3 of the n-type silicon substrate 1 located in the storage part 82 of later part relative to the mixing part 82a interposed the gate insulating film 4 therebetween. The gate electrodes 51a to 53a and 61 to 63 have a length a of about 0.7 μm in the transfer direction (direction A), and are arranged at pitch (interval between the centers) of about 0.9 μm in the transfer direction (direction A). The gate electrodes 51a to 53a of the imaging part 81 serve to form potential wells for storing and transferring the electrons in response to clock pulse signals FP1 to FP3, respectively. The gate electrodes 61 to 63 of the storage part 82 serve to form potential wells for storing and transferring the electrons in response to clock pulse signals FC1 to FC3, respectively.

In the first embodiment, as shown in FIG. 3, a gate electrode 70 of polysilicon with thickness of about 70 nm is formed above the N-well 3 of the n-type silicon substrate 1 located in the mixing part 82a interposed the gate insulating film 4 therebetween. The gate electrode 70 of the mixing part 82a has a length b of about 0.5 μm in the transfer direction (direction A) that is smaller than the length a (about 0.7 μm) of the gate electrodes 61 to 63 of the storage part 82 of later part relative to the mixing part 82a, and the gate electrodes 51a to 53a of the imaging part 81 in the transfer direction (direction A). The gate electrode 70 of the mixing part 82a serves to mix electrons corresponding to the three pixels 81a aligned in the transfer direction (direction A) in response to the clock pulse signal FC1 and to form a potential well for storing and transferring the mixed electrons. In addition, the gate electrode 70 of the mixing part 82a serves to eject excess electrons that do not affect image quality when electrons more than necessary are mixed in the mixing part 82a. The gate electrode 70 is an example of an “electron-ejection gate electrode” in the present invention.

As shown in FIG. 2, p-type channel stops 7 are formed in the N-well 3 of the n-type silicon substrate 1 at a prescribed pitch so as to extend in the transfer direction (direction A). One pixel 81a is constituted of one area divided by the p-type channel stops 7 in the formation area of three gate electrodes 51a to 53a of the imaging part 81. In FIG. 2, for ease of illustration, in the imaging part 81, although only three pixels 81a of the last stage aligned in the direction perpendicular to the transfer direction (direction A) are shown, practically, a plurality of pixels 81a are arranged in a matrix shape. In addition, in FIG. 2, although, in the storage part 82 including the mixing part 82a, only four stages of gate electrodes 70 and 61 to 63 are shown, practically, the gate electrodes the number of which corresponds to the pixels 81a of the imaging part 81 are formed.

With reference to FIG. 1 to FIG. 4, the operation of the imaging device 80 according to the first embodiment in the case of transfer frequency of about 10 MHz is now described. The diagonally shaded areas (hatched areas) in FIG. 4 show the state where electrons are stored in the potential wells, which are formed in response to the clock pulse signals. In FIG. 4, the potential of H level is shown at the lower side relative to the potential of L level.

First, in the imaging part 81 shown in FIG. 2, light is incident on each pixel 81a, and photoelectric conversion of the incident light produces electrons in each pixel 81a. In this case, the clock signal FP1 is set to H level. Accordingly, the potential well is formed in the N-well 3 (see FIG. 3) under the gate electrode 51a of the imaging part 81, and electrons are stored in the potential well.

Subsequently, the clock pulse signal FP2 is set to H level, thus, the potential well is formed in the N-well 3 under the gate electrode 52a of the imaging part 81. Accordingly, about a half electrons move from the potential well of the gate electrode 51a to the potential well of the gate electrode 52a. After that, the clock pulse signal FP1 is set to L level. Thus, the potential well of the gate electrode 51a disappears, and the rest half electrons stored in the potential well of the gate electrode 51a move to the potential well of the gate electrode 52a.

Subsequently, the clock pulse signal FP3 is set to H level, thus, the potential well is formed in the N-well 3 under the gate electrode 53a of the imaging part 81. Accordingly, about a half electrons move from the potential well of the gate electrode 52a to the potential well of the gate electrode 53a. After that, the clock pulse signal FP2 is set to L level. Thus, the potential well of the gate electrode 52a disappears, and the rest half electrons stored in the potential well of the gate electrode 52a move to the potential well of the gate electrode 53a.

Subsequently, the clock pulse signal FC1 is set to H level, thus, the potential wells are formed in the N-well 3 under the gate electrode 63 of the storage part 82 and the gate electrode 70 of the mixing part 82a. In this case, since, in the first embodiment, the length b (about 0.5 μm) of the gate electrode 70 of the mixing part 82a in the transfer direction (direction A) is smaller than the length a (about 0.7 μm) of the gate electrode 63 of the storage part 82 of later part relative to the mixing part 82a in the transfer direction (direction A), the potential well of the gate electrode 70 is smaller than the potential well of the gate electrode 63. The potential well is formed in the N-well 3 under the gate electrode 70 of the mixing part 82a, thus, about a half electrons move from the potential well of the gate electrode 53a of the imaging part 81 to the potential well of the gate electrode 70 of the mixing part 82a. After that, the clock pulse signal FP3 is set to L level. Thus, the potential well of the gate electrode 53a of the imaging part 81 disappears, and the rest half electrons stored in the potential well of the gate electrode 53a move to the potential well of the gate electrode 70 of the mixing part 82a. Thus, the electrons corresponding to one pixel 81a produced in the imaging part 81 are stored in the mixing part 82a.

After that, the operation that sequentially sets the clock pulse signals FP1 to FP3 to H level is repeated twice, and the clock pulse signal FC1 are held at H level in this period (period B in FIG. 4). Accordingly, in the first embodiment, electrons corresponding to the three pixels 81a aligned in the transfer direction (direction A) are mixed in the mixing part 82a. Furthermore, in this case, in the first embodiment, excess electrons that do not affect image quality are ejected in the mixing part 82a.

The simulation result of the state of electrons that do not affect image quality are ejected in the case where the number of electrons that can be transferred in the storage part 82 is about 6,000 is described.

With reference to FIG. 5, in the case where electrons are ejected until the number of the electrons becomes from about 18,000 to 6,000, long time of about 1 second (1×100 seconds) is required for the potential well formed by the gate electrode whose length in the transfer direction (direction A) is about 0.7 μm. In the first embodiment where the imaging device operates at transfer frequency of about 10 MHz (transfer period of about 1×10⁻⁷ seconds (about 100 ns)), the period where electrons can be ejected in the mixing part 82a is the period B in FIG. 4 (about 250 ns). Accordingly, in the case where the gate electrode with long length of about 0.7 μm in the transfer direction (direction A) which needs electronic ejection time of about 1 second is used as the mixing part 82a, it is difficult to eject the electrons stored in the mixing part 82a until the number of the electrons becomes to about 6,000 within the period B in FIG. 4. On the other hand, in the case of the potential well formed by the gate electrode whose length in the transfer direction (direction A) is about 0.5 μm, when electrons are ejected until the number of the electrons becomes from about 18,000 to about 6,000, it is possible to eject electrons in very short time of about 1×10⁻⁷ seconds (about 100 ns). Accordingly, in the first embodiment where the gate electrode 70 with small length of about 0.5 μm in the transfer direction (direction A) is used as the mixing part 82a, it is possible to eject the electrons stored in the mixing part 82a until the number of the electrons becomes to about 6,000 within the period B where electrons can be ejected in the mixing part 82a.

As mentioned above, after electrons are mixed and ejected by means of the gate electrode 70 of the mixing part 82a, as shown in FIG. 4, the clock pulse signal FC2 is set to H level, thus, the potential well is formed in the N-well 3 under the gate electrode 61 of the storage part 82 (see FIG. 3). Accordingly, about a half electrons move from the potential well of the gate electrode 70 to the potential well of the gate electrode 61. After that, the clock pulse signal FC1 is set to L level. Thus, the potential well of the gate electrode 70 disappears, and the rest half electrons stored in the potential well of the gate electrode 70 move to the potential well of the gate electrode 61. After the clock pulse signal FC3 is then set to H level, the clock pulse signal FC2 is set to L level, thus, electrons move from the potential well of the gate electrode 61 to the potential well of the gate electrode 62.

As mentioned above, the operation that sequentially sets the clock pulse signals FP1 to FP3 and FC1 to FC3 to H level is repeated, thus, electrons corresponding to one frame (all pixels 81a) stored in the imaging part 81 are transferred to the storage part 82. After that, as shown in FIG. 1, electrons stored in the storage part 82 are transferred to the horizontal transfer part 83 for every one stage (all pixels 81a aligned in the direction perpendicular to the transfer direction (direction A)), and the electrons of one stage are transferred to the output part 84.

In the first embodiment, as mentioned above, the mixing part 82a which mixes electrons corresponding to the three pixels 81a aligned in the transfer direction (direction A) is provided in the part of the storage part 82 proximity to a boundary between the imaging part 81 and the storage part 82. Accordingly, after the electrons corresponding to the three pixels 81a aligned in the transfer direction (direction A) stored in the imaging part 81 are mixed, the mixed electrons can be transferred to the storage part 82 and output. As a result, it is possible to suppress deterioration of image quality due to shortage of the amount of light, even if light incident on the imaging part 81 decreases and electrons stored in the imaging part 81 decrease. The length b (about 0.5 μm) of the gate electrode 70 of the mixing part 82a in the transfer direction (direction A) is set to be smaller than the length a (about 0.7 μm) of the gate electrodes 61 to 63 of the storage part 82 of later part relative to the mixing part 82a in the transfer direction (direction A). Thus, the potential well of the gate electrode 70 can be smaller than the potential wells of the gate electrodes 61 to 63. Accordingly, electrons that can be stored in the potential well of the gate electrode 70 of the mixing part 82a is fewer than the potential wells of the gate electrodes 61 to 63 of the storage part 82 of later part relative to the mixing part 82a. This allows quick ejection of excess electrons in the mixing part 82a that do not affect image quality. For this reason, since the excess electrons can be quickly ejected even if electrons more than necessary are mixed in the mixing part 82a, long time is not required for ejection of the excess electrons. As a result, in the case where the electrons corresponding to the three pixels 81a are mixed by the mixing part 82a to suppress deterioration of image quality due to shortage of the amount of light, it is possible to suppress reduction of transfer rate. Therefore, it is possible to suppress occurrence of light noise (smear) due to incident of light in transfer.

In the first embodiment, electrons corresponding to the three pixels 81a mixed by the mixing part 82a are transferred to the storage part 82. Accordingly, it is only required to store mixed electrons corresponding to the three pixels 81a as electrons corresponding to one pixel 81a in the storage part 82. This can provide the formation area of the storage part 82 that is smaller than the formation area of the imaging part 81. Therefore, it is possible to achieve size reduction of the frame transfer type imaging device 80 having the storage part 82.

### Second Embodiment

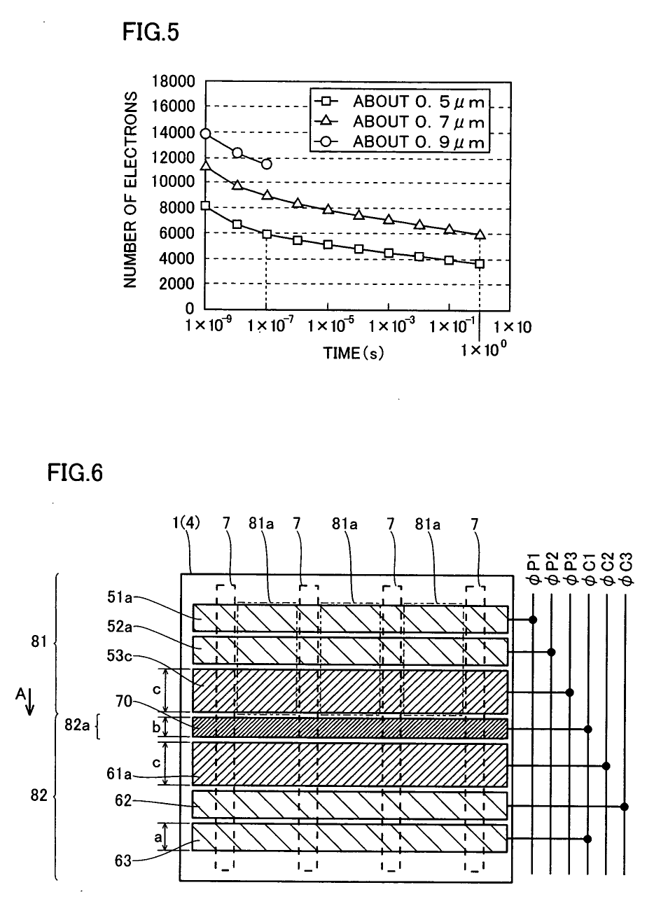

With reference to FIG. 6, in a second embodiment, the case where gate electrodes with long length of about 1.2 μm in the transfer direction (direction A) are formed at the both sides in the transfer direction (direction A) of the gate electrode 70 of the mixing part 82a with length of about 0.5 μm in the transfer direction (direction A) is described, dissimilarly to the foregoing first embodiment.

As shown in FIG. 6, in the second embodiment, the pixel 81a of the last row of the imaging part 81 is constituted of the gate electrodes 51a and 52a, and a gate electrode 53c. The gate electrode 53c adjacent to the gate electrode 70 of the mixing part 82a has a length c of about 1.2 μm in the transfer direction (direction A). The gate electrode 53c serves to form a potential well for storing and transferring electrons in response to the clock pulse signal FP3. The pixel 81a of a row before the last row of the imaging part 81 is constituted of the gate electrodes 51a to 53a with length a of about 0.7 μm in the direction (direction A), similarly to the foregoing first embodiment.

In the second embodiment, in the storage part 82 including the mixing part 82a, a gate electrode 61a with length c of about 1.2 μm in the transfer direction (direction A) is formed in the second stage adjacent to the gate electrode 70 of the mixing part 82a. The gate electrode 61a serves to form a potential well for storing and transferring electrons in response to the clock pulse signal FC2. The gate electrodes 62 and 63 with length a of about 0.7 μm in the transfer direction (direction A) are formed in the third and fourth stages in the storage part 82 including the mixing part 82a, respectively.

In addition, the other constitution in the second embodiment is similar to the foregoing first embodiment.

In the second embodiment, as mentioned above, the gate electrode 53c (the imaging part 81 side) and the gate electrode 61a (the storage part 82 side) with long length of about 1.2 μm in the transfer direction (direction A) are formed at the both sides in the transfer direction (direction A) of the gate electrode 70 of the mixing part 82a with length b of about 0.5 μm in the transfer direction (direction A). Accordingly, the interval in the transfer direction (direction A) between the potential well of the gate electrode 70 of the mixing part 82a and the potential well of the gate electrode 52a adjacent to the gate electrode 53c of the imaging part 81, and the interval in the transfer direction (direction A) between the potential well of the gate electrode 70 of the mixing part 82a and the potential well of the gate electrode 62 adjacent to the gate electrode 61a of the storage part 82 can be large. Accordingly, it is possible to suppress that electrons ejected from the potential well of the gate electrode 70 of the mixing part 82a pass over the potential barriers under the gate electrodes 53c and 61a, and are mixed into the adjacent potential wells. Therefore, it is possible to further suppress deterioration of image quality as compared with the first embodiment.

In addition, the other effects in the second embodiment are similar to the foregoing first embodiment.

### Third Embodiment

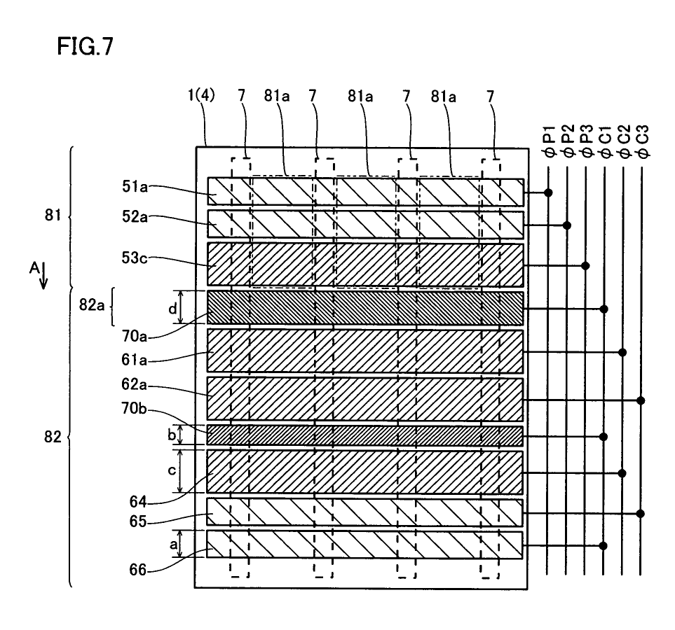

With reference to FIG. 7, in a third embodiment, dissimilarly to the foregoing second embodiment, the case where an electron-ejection gate electrode is provided in the storage part 82 of a later stage relative to the mixing part 82a is described.

In the third embodiment, as shown in FIG. 7, a gate electrode 70a with length d of about 0.9 μm in the transfer direction (direction A) is formed in the mixing part 82a. The gate electrode 70a serves to mix electrons corresponding to the three pixels 81a aligned in the transfer direction (direction A) in response to the clock pulse signal FC1 and to form a potential well for storing and transferring the mixed electrons. The gate electrode 70a is an example of an “electron-mixing gate electrode” in the present invention. A gate electrode 70b with length b of about 0.5 μm in the transfer direction (direction A) is formed in the fourth stage in the storage part 82 including the mixing part 82a. The gate electrode 70b also serves to form a potential well for storing and transferring electrons in response to the clock pulse signal FC1. In addition, the gate electrode 70b serves to eject excess electrons that do not affect image quality when electrons more than necessary are mixed in the mixing part 82a. The gate electrode 70b is an example of the “electron-ejection gate electrode” in the present invention.

In the third embodiment, a gate electrode 62a (third stage) and a gate electrode 64 (fifth stage) with long length of about 1.2 μm in the transfer direction (direction A) are formed at the both sides in the transfer direction (direction A) of the gate electrode 70b with length b of about 0.5 μm. The gate electrodes 65 and 66 with length a of about 0.7 μm in the transfer direction (direction A) are formed in the sixth and seventh stages in the storage part 82 including the mixing part 82a, respectively.

In addition, the other constitution in the third embodiment is similar to the foregoing first embodiment.

Referring to the operation of the imaging device according to the third embodiment, electrons stored in the imaging part 81 are sequentially transferred to the storage part 82 and the horizontal transfer part 83 (see FIG. 1) at timing similar to the first embodiment shown in FIG. 4.

In the third embodiment, excess electrons ejected in the mixing part 82a are fewer as compared with the foregoing first embodiment. Specifically, as shown in FIG. 5, in the case of the potential well of the gate electrode 70b with length of about 0.5 μm in the transfer direction (direction A) (first embodiment), time required for ejection of electrons until the number of the electrons becomes from about 18,000 to about 6,000 is about 1×10⁻⁷ second (about 100 ns). On the other hand, in the potential well of the gate electrode 70a whose length in the transfer direction (direction A) is about 0.9 μm (third embodiment), if ejection time is about 1×10⁻⁷ seconds (about 100 ns) similar to the gate electrode 70b with length of about 0.5 μm in the transfer direction (direction A), electrons can be ejected so that the number of the electrons becomes from about 18,000 to only about 12,000. That is, in the case of the same ejection time of about 1×10⁻⁷ seconds (about 100 ns), about 12,000 electrons are ejected in the foregoing first embodiment, on the other hand, about 6,000 electrons are ejected in the third embodiment.

In the third embodiment, excess electrons are also ejected in the fourth stage (the gate electrode 70b with length of about 0.5 μm in the transfer direction (direction A)) in the storage part 82 including the mixing part 82a. For example, if about 12,000 electrons are transferred to the fourth stage in which the gate electrode 70b is formed, electrons can be ejected until the number of the electrons becomes to about 6,000.

In the third embodiment, as mentioned above, the gate electrode 70b with length b of about 0.5 μm in the transfer direction (direction A) is formed in the fourth stage in the storage part 82 including the mixing part 82a. Accordingly, in the mixing part 82a, even in the case where the amount of ejected excess electrons that do not affect image quality is small, in the fourth stage in the storage part 82 including the mixing part 82a, the excess electrons can be quickly ejected. In addition, since excess electrons are ejected in two parts of the mixing part 82a (gate electrode 70a) and the fourth stage (gate electrode 70b) in the storage part 82 including the mixing part 82a in a distributed manner, it is possible to reduce both the number of excess electrons ejected in the mixing part 82a and the number of excess electrons ejected in the fourth stage in the storage part 82 including the mixing part 82a. Accordingly, it is possible to suppress that excess electrons ejected from the potential well of gate electrode 70a pass over the potential barriers of the gate electrode 53c (the imaging part 81 side) and the gate electrode 61a (the storage part 82 side) located at the both sides in the transfer direction (direction A) of the gate electrode 70a of the mixing part 82a, and are mixed into the adjacent potential wells. In addition, it is possible to suppress that excess electrons ejected from the potential well of gate electrode 70b pass over the potential barriers of the gate electrodes 62a and 64 located at both sides in the transfer direction (direction A) of the gate electrode 70b of the fourth stage of the storage part 82 including the mixing part 82a, and are mixed into the adjacent potential wells. As a result, it is possible to further suppress deterioration of image quality as compared with the foregoing second embodiment. Furthermore, since the gate electrode 70b is driven in response to the clock pulse signal FC1, in the period B (see FIG. 4) where the potential well of the gate electrode 70b is formed, it is possible to elongate a period where only the potential well corresponding to the gate electrode 70b, of the gate electrode 70b and the gate electrodes 62a and 64 which are adjacent to the gate electrode 70b, are formed. Thus, in the fourth stage in the storage part 82 including the mixing part 82a, it is possible to provide enough ejection time of excess electrons.

Moreover, in the third embodiment, the gate electrodes 62a and 64 with long length c of about 1.2 μm in the transfer direction (direction A) are formed at the both sides in the transfer direction (direction A) of the gate electrode 70b with length b of about 0.5 μm in the transfer direction (direction A). Accordingly, it is possible to suppress that electrons ejected from the potential well of the gate electrode 70b pass over the potential barriers under the gate electrodes 62a and 64, and are mixed into the adjacent potential wells similarly to the foregoing second embodiment. Therefore, it is possible to further suppress deterioration of image quality.

In addition, the other effects in the third embodiment are similar to the foregoing first and second embodiments.

### Fourth Embodiment

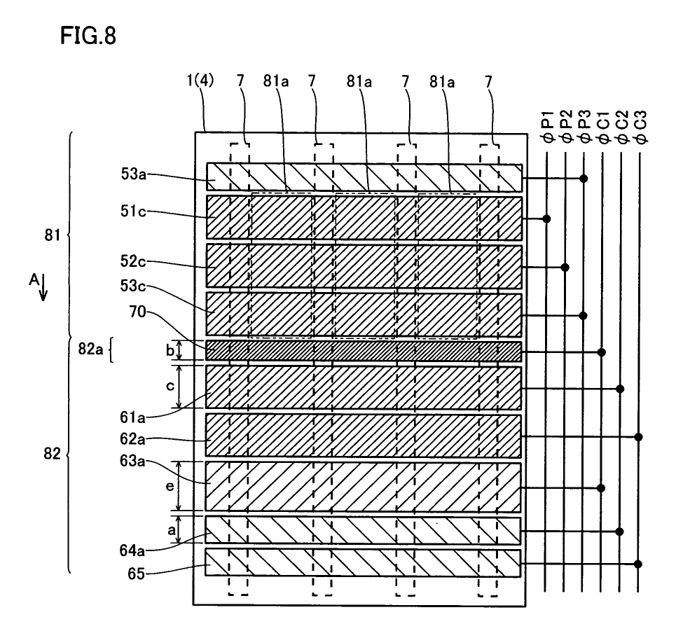

With reference to FIG. 8, in a fourth embodiment, dissimilarly to the foregoing second embodiment, the case where the lengths in the transfer direction (direction A) of gate electrodes are adjusted so that the totals of plane areas (load capacities) of the respective gate electrodes connected to the clock pulse signal lines FP1 to FP3 and FC1 to FC3 are equal is described.

As shown in FIG. 8, in the fourth embodiment, similarly to the foregoing second embodiment, the gate electrodes 53c (the imaging part 81 side) and 61a (the storage part 82 side) with length c of about 1.2 μm in the transfer direction (direction A) are formed at the both sides in the transfer direction (direction A) of the gate electrode 70 with length b of about 0.5 μm in the transfer direction (direction A) of the mixing part 82a. The gate electrode 70 of the mixing part 82a is connected to the clock pulse signal line FC1. The gate electrode 53c of the imaging part 81 and the gate electrode 61a of the storage part 82 are connected to the clock pulse signal lines FP3 and FC2, respectively.

In the fourth embodiment, the pixel 81a of the last stage of the imaging part 81 is constituted of gate electrodes 51c and 52c, and the gate electrode 53c. The gate electrode 51c connected to the clock pulse signal line FP1 has the length c of about 1.2 μm in the transfer direction (direction A). The gate electrode 52c connected to the clock pulse signal line FP2 also has the length c of about 1.2 μm in the transfer direction (direction A). The gate electrode 53c connected to the clock pulse signal line FP3 is also formed so as to have the length c of about 1.2 μm in the transfer direction (direction A) as mentioned above. The pixel 81a of a stage before the last stage of the imaging part 81 is constituted of the gate electrodes 51a to 53a with length a of about 0.7 μm in the direction (direction A), similarly to the foregoing second embodiment. Accordingly, in the fourth embodiment, the clock pulse signal lines FP1 to FP3, which are connected to a plurality of gate electrodes 51a to 53a with length a of about 0.7 μm in the transfer direction (direction A), respectively, are connected to the gate electrodes 51c to 53c with length c of about 1.2 μm in the transfer direction (direction A) for one each, respectively. Thus, since the totals of lengths in the transfer direction (direction A) of the respective gate electrodes connected to the clock pulse signal lines FP1 to FP3 are equal to each other, the totals of plane areas of the respective gate electrodes connected to the clock pulse signal lines FP1 to FP3 are equal.

In the fourth embodiment, in the storage part 82 including the mixing part 82a, the gate electrode 62a with length c of about 1.2 μm in the transfer direction (direction A) is formed in the third stage to which the clock pulse signal line FC3 is connected. A gate electrode 63a with length e of about 1.4 μm in the transfer direction (direction A) is formed in the fourth stage to which the clock pulse signal line FC1 is connected. A gate electrode 64a with length a of about 0.7 μm in the transfer direction (direction A) is formed in the fifth stage to which the clock pulse signal line FC2 is connected. The gate electrode 65 with length a of about 0.7 μm in the transfer direction (direction A) is formed in the sixth stage to which the clock pulse signal line FC3 is connected. The gate electrode 70 of first stage to which the clock pulse signal line FC1 is connected and the gate electrode 61a of second stage to which the clock pulse signal FC2 is connected have the length b of about 0.5 μm in the transfer direction (direction A) and the length c of about 1.2 μm in the transfer direction (direction A), respectively, as mentioned above. Accordingly, in the fourth embodiment, the totals of lengths in the transfer direction of the respective gate electrodes connected to the clock pulse signal lines FC1 to FC3 are equal. Therefore, the totals of plane areas of the respective gate electrodes connected to the clock pulse signal lines FC1 to FC3 are equal.

In addition, the other constitution in the fourth embodiment is similar to the foregoing first embodiment.

In the fourth embodiment, the clock pulse signal lines FP1 to FP3, which are connected to a plurality of gate electrodes 51a to 53a with length a of about 0.7 μm in the transfer direction (direction A), respectively, are connected to the gate electrodes 51c to 53c with length c of about 1.2 μm in the transfer direction (direction A) for one each, respectively, as mentioned above. Thus, the totals of plane areas of the respective gate electrodes connected to the clock pulse signal lines FP1 to FP3 can be equal. Furthermore, the gate electrode 63a with length e of about 1.4 μm in the transfer direction (direction A) is connected to the clock pulse signal line FC1 to which the gate electrode 70 with length b of about 0.5 μm in the transfer direction (direction A) is connected. In addition, the clock pulse signal lines FC2 and FC3 are connected to the gate electrodes 61a and 62a with length c of about 1.2 μm in the transfer direction (direction A), respectively, and are connected to the gate electrodes 64a and 65 with length a of about 0.7 μm in the transfer direction (direction A), respectively. Thus, the totals of plane areas of the respective gate electrodes connected to the clock pulse signal lines FC1 to FC3 can be equal. Accordingly, the load capacities of the respective gate electrodes of phases can be substantially equal to each other. As a result, it is possible to suppress deviation of timing of turning to ON state or OFF state of some of the gate electrodes due to occurrence of difference among the load capacities of the respective gate electrodes of phases.

In addition, the other effects in the fourth embodiment are similar to the foregoing second embodiment.

### Fifth Embodiment

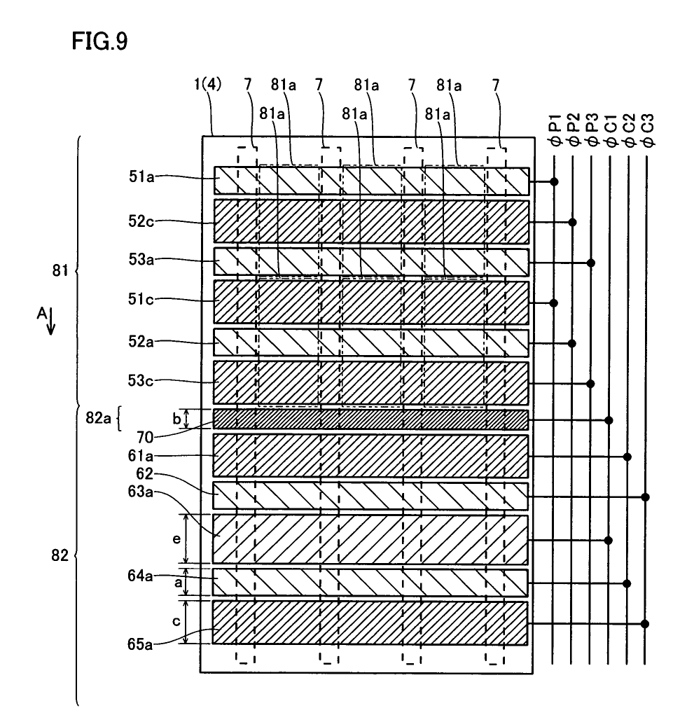

With reference to FIG. 9, in a fifth embodiment, dissimilarly to the foregoing fourth embodiment, the case where gate electrodes with long length of about 1.2 μm or more in the transfer direction (direction A) are arranged so that they are not adjacent to each other is described.

As shown in FIG. 9, in the fifth embodiment, similarly to the foregoing fourth embodiment, the gate electrodes 53c (the imaging part 81 side) and 61a (the storage part 82 side) with length c of about 1.2 μm in the transfer direction (direction A) are formed at the both sides in the transfer direction (direction A) of the gate electrode 70 with length b of about 0.5 μm in the transfer direction (direction A) of the mixing part 82a.

In the fifth embodiment, dissimilarly to the foregoing fourth embodiment, the pixel 81a of the last stage of the imaging part 81 is constituted of the gate electrodes 51c, 52a and 53c. The gate electrode 52a connected to the clock pulse signal line FP2 has the length a of about 0.7 μm in the transfer direction (direction A). Accordingly, the gate electrodes 51c and 53c with long length c of about 1.2 μm in the transfer direction (direction A) are arranged so that they are not adjacent to each other. The pixel 81a of the stage previous to the last stage of the imaging part 81 is constituted of the gate electrodes 51a, 52c and 53a. The gate electrode 52c connected to the clock pulse signal line FP2 has the length c of about 1.2 μm in the transfer direction (direction A). Accordingly, the clock pulse signal lines FP1 to FP3 are connected to the gate electrodes 51a to 53a with length a of about 0.7 μm in the transfer direction (direction A), respectively, and are connected to the gate electrodes 51c to 53c with length c of about 1.2 μm in the transfer direction (direction A), respectively. Thus, since the totals of lengths in the transfer direction (direction A) of the respective gate electrodes connected to the clock pulse signal lines FP1 to FP3 are equal to each other, the totals of plane areas of the respective gate electrodes connected to the clock pulse signal lines FP1 to FP3 are equal. In addition, the gate electrodes 51c and 52c with long length c of about 1.2 μm in the transfer direction (direction A) are arranged so that they are not adjacent to each other.

In the fifth embodiment, dissimilarly to the foregoing fourth embodiment, in the storage part 82 including the mixing part 82a, the gate electrode 62 with length a of about 0.7 μm in the transfer direction (direction A) is formed in the third stage to which the clock pulse signal line FC3 is connected. Accordingly, the gate electrode 61a of second stage with long length c of about 1.2 μm in the transfer direction (direction A), and the gate electrode 63a of fourth stage with long length e of about 1.4 μm in the transfer direction (direction A) are arranged so that they are not adjacent to each other. A gate electrode 65a with length c of about 1.2 μm in the transfer direction (direction A) is formed in the sixth stage to which the clock pulse signal line FC3 is connected. Accordingly, the clock pulse signal line FC1 is connected to the gate electrode 70 with length b of about 0.5 μm in the transfer direction (direction A) and the gate electrode 63a with length e of about 1.4 μm in the transfer direction (direction A), respectively. In addition, the clock pulse signal lines FC2 and FC3 are connected to the gate electrodes 61a to 65 with length c of about 1.2 μm in the transfer direction (direction A), respectively, and are connected to the gate electrodes 64a and 62c with length a of about 0.7 μm in the transfer direction (direction A), respectively. Thus, since the totals of lengths in the transfer direction of the respective gate electrodes connected to the clock pulse signal lines FC1 to FC3 are equal, the totals of plane areas of the respective gate electrodes connected to the clock pulse signal lines FC1 to FC3 are equal. In addition, the gate electrodes 63a and 65a with long length of about 1.2 μm or more in the transfer direction (direction A) are arranged so that they are not adjacent to each other.

In addition, the other constitution in the fifth embodiment is similar to the foregoing first embodiment.

In the fifth embodiment, as mentioned above, the gate electrodes 51c to 53c, 61a, 63a and 65a with long length of about 1.2 μm or more in the transfer direction (direction A) are arranged so that they are not adjacent to each other. Accordingly, it is possible to suppress increase of area where an electric field is generated due to simultaneously turning to ON state of the gate electrodes with long length of about 1.2 μm or more in the transfer direction (direction A). Therefore, it is possible to suppress recombination of electrons in the surface of the n-type silicon substrate 1 or inflow of electrons from the n-type silicon substrate 1.

Moreover, in the fifth embodiment, similarly to the foregoing fourth embodiment, the load capacities of the respective gate electrodes of phases can be substantially equal to each other. As a result, it is possible to suppress deviation of timing of turning to ON state or OFF state of some of the gate electrodes due to occurrence of difference among the load capacities of the respective gate electrodes of phases.

In addition, the other effects in the fifth embodiment are similar to the foregoing second embodiment.

It should be appreciated, however, that the embodiments described above are illustrative, and the invention is not specifically limited to description above. The invention is defined not by the foregoing description of the embodiments, but by the appended claims, their equivalents, and various modifications that can be made without departing from the scope of the invention as defined in the appended claims.

The case where electrons corresponding to the three pixels are mixed is described in each of the foregoing first to fifth embodiments, however, the present invention is not limited to this case. Similar effects can be obtained as long as electrons corresponding to two or more pixels are mixed, for example.

The mixing part, which mixes electrons corresponding to two or more pixels, is provided in the storage part in each of the foregoing first to fifth embodiments, however, the present invention is not limited to this constitution. The mixing part may be provided in the area other than the storage part. For example, the mixing part can be provided in the area between the imaging part and the storage part separately from the imaging part and the storage part.

The case where the present invention is applied to the frame transfer type imaging device in each of the foregoing first to fifth embodiments, however, the present invention is not limited to this case. The present invention can be applied to an interline type imaging device. In the case where the present invention is applied to an interline type imaging device, the mixing part is preferably provided between the imaging part and the horizontal transfer part.

Electrons are transferred by using the three phases of clock pulse signals in each of the foregoing first to fifth embodiments, however, the present invention is not limited to this. Electrons may transferred by using clock pulse signals other than the three phases of clock pulse signals. For example, electrons can be transferred by using two phases or four phases of clock pulse signals.

In the foregoing third embodiment, one electron-ejection gate electrode is provided in the storage part of a later stage relative to the mixing part, however, the present invention is not limited to this constitution. The imaging device may includes at least two the electron-ejection gate electrodes in the storage part of the later stage relative to the mixing part so that the respective lengths in the transfer direction of the at least two electron-ejection gate electrodes decrease as they are positioned later in stages. With this constitution, excess electrons are ejected in three parts or more of the mixing part provided with the electron-mixing gate electrode and later stages relative to the mixing part, which are provided with the at least two electron-ejection gate electrodes, in a distributed manner. Accordingly, it is possible to further reduce the number of excess electrons ejected in the electron-mixing gate electrode and the each number of excess electrons ejected in each of the at least two electron-ejection gate electrodes. As a result, it is possible to further suppress that excess electrons ejected from the electron-mixing gate electrode and the electron-ejection gate electrodes pass over the potential barriers of the gate electrodes located at the both sides in the transfer direction of the electron-mixing gate electrode and the electron-ejection gate electrodes, and are mixed into the adjacent potential wells. Therefore, it is possible to further suppress deterioration of image quality.

1. An imaging device comprising:
an imaging part which performs photoelectric conversion;
a mixing part which mixes electrons corresponding to at least two of pixels transferred from said imaging part; and
an electron-ejection gate electrode which has a length in the transfer direction smaller than the length in the transfer direction of a gate electrode of later stage and ejects said electrons mixed by said mixing part.

2. The imaging device according to claim 1, wherein said electron-ejection gate electrode is provided in said mixing part, and forms an potential well which serves to mix said electrons corresponding to the at least two of said pixels transferred from said imaging part and to ejects said mixed electrons.

3. The imaging device according to claim 2, wherein a potential well for mixing said electrons corresponding to the at least two of said pixels is formed by setting a signal provided to said electron-ejection gate electrode to a prescribed potential level, wherein
said prescribed potential level of said signal provided to said electron-ejection gate electrode is held during a period where said electrons corresponding to the at least two of said pixels are transferred to said potential well.

4. The imaging device according to claim 3, wherein said electron-ejection gate electrode ejects said electrons the number of which is beyond the number of said electrons that can be stored in said potential well formed by said electron-ejection gate electrode.

5. The imaging device according to claim 1, wherein said mixing part mixes said electrons corresponding to adjacent three of said pixels in said transfer direction transferred from said imaging part.

6. The imaging device according to claim 1, wherein said mixing part includes an electron-mixing gate electrode which mixes said electrons corresponding to the at least two of said pixels transferred from said imaging part, wherein
said electron-ejection gate electrode is arranged in a later stage relative to the electron-mixing gate electrode of said mixing part.

7. The imaging device according to claim 6, wherein said electron-mixing gate electrode of said mixing part has a length in said transfer direction longer than the length in said transfer direction of said electron-ejection gate electrode.

8. The imaging device according to claim 1, wherein the apparatus includes at least two said electron-ejection gate electrodes, wherein
the respective lengths in said transfer direction of said at least two electron-ejection gate electrodes decrease as they are positioned later in stages.

9. The imaging device according to claim 8, wherein one of said at least two electron-ejection gate electrodes is provided in said mixing part, and an potential well formed by the electron-ejection gate electrode of said mixing part serves to mix said electrons corresponding to the at least two of said pixels transferred from said imaging part and to eject said mixed electrons.

10. The imaging device according to claim 9, wherein the number of said electrons ejected by said electron-ejection gate electrode of said mixing part is smaller than the number of said electrons ejected by said electron-ejection gate electrode positioned in a later stage relative to said mixing part.

11. The imaging device according to claim 1, wherein gate electrodes positioned at the both sides in said transfer direction of said electron-ejection gate electrode have lengths in the transfer direction longer than the length in said transfer direction of said electron-ejection gate electrode.

12. The imaging device according to claim 1, wherein the device further comprises a storage part which stores the electrons, which are produced due to said photoelectric conversion and transferred from said imaging part, wherein
said electrons mixed by said mixing part are transferred to said storage part.

13. The imaging device according to claim 12, wherein said storage part serves to store said electrons corresponding to the at least two of said pixels as electrons corresponding to one pixel.

14. The imaging device according to claim 12, wherein said mixing part is provided in a part of said storage part proximity to a boundary between said imaging part and said storage part.

15. The imaging device according to claim 14, wherein said electron-ejection gate electrode is provided in said mixing part located in the part of said storage part proximity to a boundary between said imaging part and said storage part.

16. The imaging device according to claim 15, wherein said electron-ejection gate electrode has a length in said transfer direction smaller than the length in said transfer direction of the gate electrode of said storage part.

17. The imaging device according to claim 15, wherein the gate electrode of said imaging part adjacent to said electron-ejection gate electrode has a length in said transfer direction longer than the length in said transfer direction of said electron-ejection gate electrode, and the gate electrode of said storage part adjacent to said electron-ejection gate electrode has a length in said transfer direction longer than the length in said transfer direction of said electron-ejection gate electrode.

18. The imaging device according to claim 12, wherein
said imaging part, said mixing part, and said storage part are driven based on a plurality of phases of clock pulse signals, wherein
in each of the imaging part and the storage part, the length in said transfer direction of at least one gate electrode in said imaging part, said mixing part, and said storage part is adjusted so that the load capacities of the respective gate electrodes of phases are substantially equal to each other.

19. The imaging device according to claim 18, wherein a plurality of gate electrodes which are adjusted so that their lengths in said transfer direction are longer than other gate electrodes are included as the gate electrodes with the adjusted length in said transfer direction, wherein
the plurality of gate electrodes, which are adjusted so that their lengths in said transfer direction are larger, are arranged so that they are not adjacent to each other.
